(19) United States
(12) Patent Application Publication
(10) Pub. No.: US 2012/0011115 A1
(43) Pub. Date: Jan. 12, 2012

(54) TABLE SEARCH USING RECOVERED SEMANTIC INFORMATION

(76) Inventors: Jayant Madhavan, San Francisco, CA (US); Chung M. Wu, Sunnyvale, CA (US); Alon Halevy, Los Altos, CA (US); Gengxin Miao, Elk Grove, CA (US); Marius Pasca, Sunnyvale, CA (US); Warren H. Y. Shen, San Jose, CA (US)

(21) Appl. No.: 13/179,413

(22) Filed: Jul. 8, 2011

Related U.S. Application Data
(60) Provisional application No. 61/363,171, filed on Jul. 9, 2010.

(51) Int. Cl. G06F 17/30

(52) U.S. Cl. 707/723; 707/736; 707/740; 707/E17.09; 707/E17.014

(57) ABSTRACT

Methods, systems, and apparatus, including computer programs encoded on a computer storage medium, for searching tables using recovered semantic information. In general, one aspect of the subject matter described in this specification can be embodied in methods that include the actions of receiving a collection of tables, each table including a plurality of rows, each row including a plurality of cells; recovering semantic information associated with each table of the collection of tables, the recovering including determining a class associated with each respective table according to a class-instance hierarchy including identifying a subject column of each table of the collection of tables; and labeling each table in the collection of tables with the respective class.

### CROSS-REFERENCE TO RELATED APPLICATIONS

This application claims the benefit under 35 U.S.C. §119(e) to U.S. Provisional Application Ser. No. 61/363,171, filed on Jul. 9, 2010, and which is incorporated by reference in its entirety.

### BACKGROUND

This specification relates to searching tables using recovered semantic information.

Internet search engines aim to identify resources (e.g., web pages, images, text documents, multimedia context) that are relevant to a user's needs and to present information about the resources in a manner that is most useful to the user. Internet search engines return a set of search results in response to a user submitted query.

Many resources include tables. For example, a web page can include one or more tables of data. Additionally, tables can be included within resources of enterprise or individual repositories (e.g., a government repository). However, searching for a particular table can be difficult because the semantics of the table are typically not explicit within the table itself. Thus, conventional signals for searching documents or other resources can be of limited use in searching for table data.

### SUMMARY

This specification describes technologies relating to searching tables using recovered semantic information.

In general, one aspect of the subject matter described in this specification can be embodied in methods that include the actions of receiving a collection of tables, each table including a plurality of rows, each row including a plurality of cells; recovering semantic information associated with each table of the collection of tables, the recovering including determining a class associated with each respective table according to a class-instance hierarchy including identifying a subject column of each table of the collection of tables; and labeling each table in the collection of tables with the respective class.

Other embodiments of this aspect include corresponding systems, apparatus, and computer program products. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. One or more tables are identified from web pages. A first column of each table is designated as the subject column of the table. A subject column of each table is identified using a support vector machine classifier. Classifying each table into classes in a class-instance hierarchy includes identifying a ranked list of classes that describe instances in the subject column. The method further includes storing the collection of labeled tables. The method further includes receiving a query in a form of a class and property and using the collection of labeled tables to identify one or more labeled tables that match the class and the property.

The method further includes identifying a class-instance hierarchy, the class-instance hierarchy being generated from a class-instance repository formed by identifying patterns from a collection of text and a collection of queries. Classifying includes: computing a candidate collection of classes for each cell in a subject column of the table; and assigning class labels for the subject column of the table as a merged ranked list from the candidate lists for each cell.

In general, one aspect of the subject matter described in this specification can be embodied in methods that include the actions of receiving a query, the query having a plurality of terms where at least one term of the plurality of terms identifies a class and at least one term of the plurality of terms identifies a property of the class; identifying tables in a collection of tables that are labeled with a same class as the query; identifying one or more tables of the tables having the same class that also include the property of the query; and ranking the one or more tables. Other embodiments of this aspect include corresponding systems, apparatus, and computer program products.

These and other embodiments can optionally include one or more of the following features. The method further includes presenting at least one of the one or more tables for display. The at least one of the one or more tables are presented along with one or more non-table search results responsive to the query. The one or more tables are ranked according to a criteria based on the content of the one or more tables. The one or more tables are ranked according to a size of the one or more tables. Each table of the collection of tables is labeled according to a class-instance hierarchy, where determining class for a particular table of the collection includes identifying a subject column of the table.

Particular embodiments of the subject matter described in this specification can be implemented so as to realize one or more of the following advantages. Users can search for tables based on recovered semantic information. The recovered semantic information provides high accuracy in searching for tables responsive to a particular query.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example search system.

FIG. 2 is a flow diagram of an example method for searching tables.

FIG. 3 is a flow diagram of an example method for recovering semantic information from tables.

FIG. 4 is a flow diagram of an example method for searching tables using recovered table semantics.

Like reference numbers and designations in the various drawings indicate like elements.

### DETAILED DESCRIPTION

Semantic information is recovered from each table of a collection of tables. Recovering semantic information can include classifying the table according to a class hierarchy. In response to a received query, the recovered semantic information for the collection of tables can be used to identify one or more tables responsive to the query.

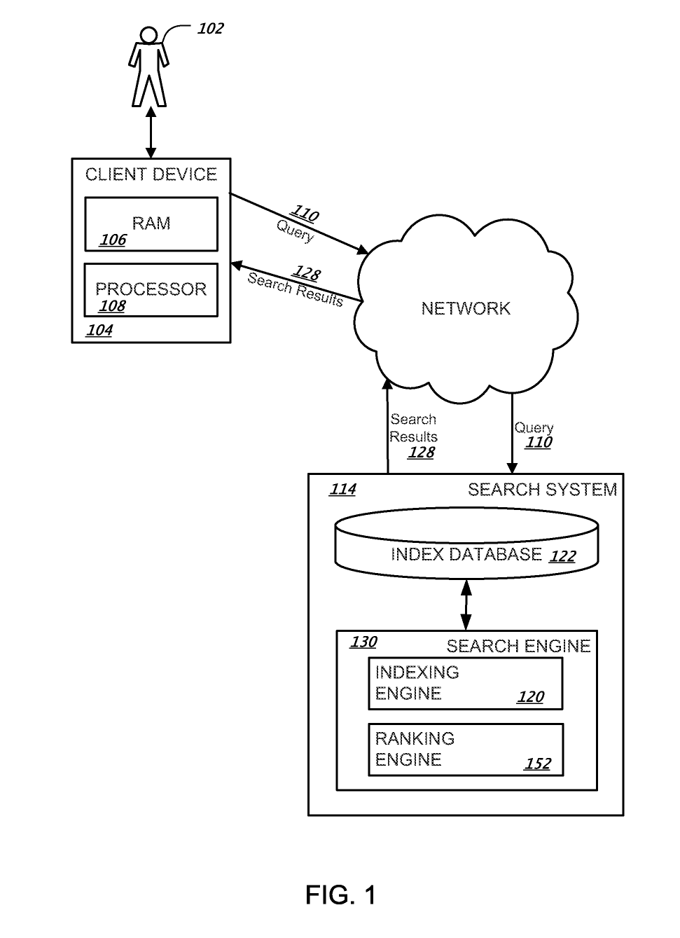

FIG. 1 is an example search system 114 for providing search results relevant to submitted queries as can be implemented in an internet, an intranet, or another client and server environment. The search system 114 is an example of an information retrieval system in which the systems, components, and techniques described below can be implemented.

A user 102 can interact with the search system 114 through a client device 104. For example, the client 104 can be a computer coupled to the search system 114 through a local area network (LAN) or wide area network (WAN), e.g., the Internet. In some implementations, the search system 114 and the client device 104 are one machine. For example, a user can install a desktop search application on the client device 104. The client device 104 will generally include a random access memory (RAM) 106 and a processor 108.

A user 102 can submit a query 110 to a search engine 130 within a search system 114. When the user 102 submits a query 110, the query 110 is transmitted through a network to the search system 114. The search system 114 can be implemented as, for example, computer programs running on one or more computers in one or more locations that are coupled to each other through a network. The search system 114 includes an index database 122 and a search engine 130. The search system 114 responds to the query 110 by generating search results 128, which are transmitted through the network to the client device 104 in a form that can be presented to the user 102 (e.g., as a search results web page to be displayed in a web browser running on the client device 104).

When the query 110 is received by the search engine 130, the search engine 130 identifies resources that match the query 110. The search engine 130 will generally include an indexing engine 120 that indexes resources (e.g., web pages, images, or news articles on the Internet) found in a corpus (e.g., a collection or repository of content), an index database 122 that stores the index information, and a ranking engine 152 (or other software) to rank the resources that match the query 110. The indexing and ranking of the resources can be performed using conventional techniques. In some implementations, tables are indexed in the index database 122. Tables can be indexed by the indexing engine 120 based on recovered semantic information. The search engine 130 can transmit the search results 128 through the network to the client device 104 for presentation to the user 102.

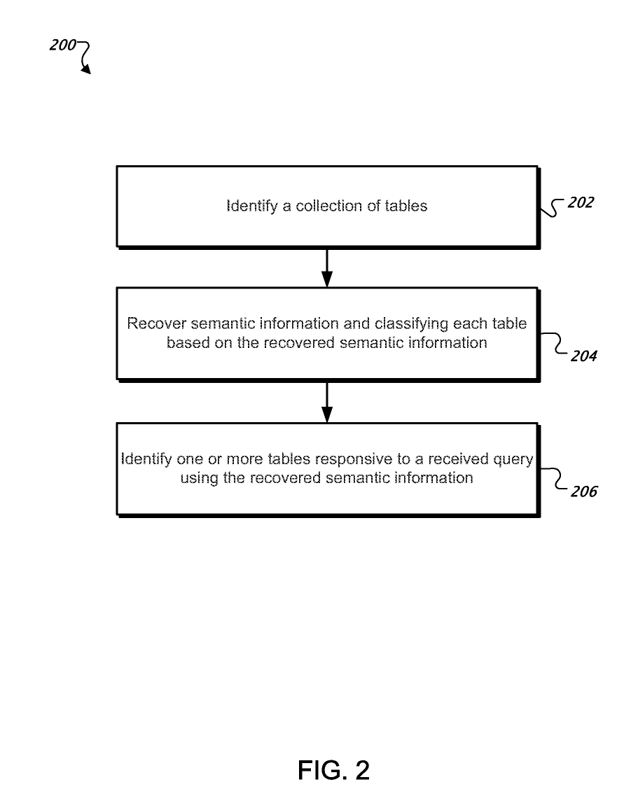

FIG. 2 is a flow diagram of an example method 200 for searching tables. For convenience, method 200 will be described with respect to a system including one or more computing devices that performs the method 200.

The system identifies 202 a collection of tables. The collection of tables can include one or more of a collection of web tables and tables from enterprise or individual repositories. The tables can be identified, for example, by crawling the web or one or more repositories to identify or extract table information. In some implementations, each table includes a set of rows where each row is a sequence of cells. The cells can each include one or more data values. The tables can be structured or semi-structured.

The data and format of each table can vary. A particular table can have incomplete information. For example, the table may not have a title identifying what is being represented by the table. Attributes in the table can lack names. The first row of the table can identify attributes names or, alternatively, data values associated with unnamed attributes. Furthermore, the row values can have multiple data types. In addition, a table can include comment or sub-header rows in the table.

In some implementations, tables identified from a collection of data (e.g., from web documents) are filtered to remove empty tables, form tables, calendar tables, and very small tables (e.g., tables with only one column or less than five rows). Additionally, HTML layout tables can be omitted. The tables following filtering can be the collection of tables.

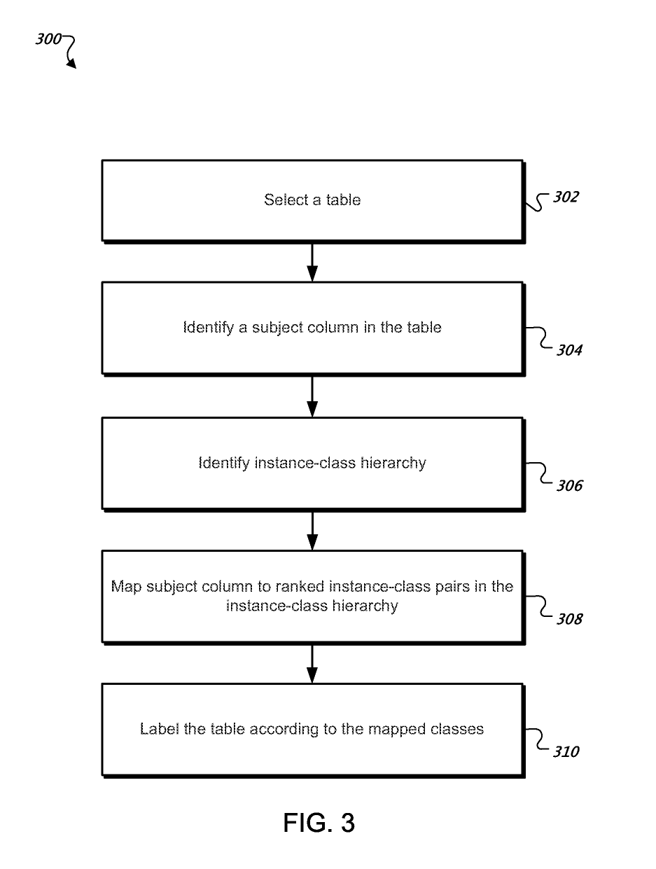

The system recovers 204 semantic information from each of the tables in the identified collection of tables to classify each table. Recovering semantic information includes identifying a column from each table corresponding to a subject of the table and using the identified subject columns to classify the table according to classes from a class hierarchy. Recovering semantic information is described in greater detail below with respect to FIG. 3.

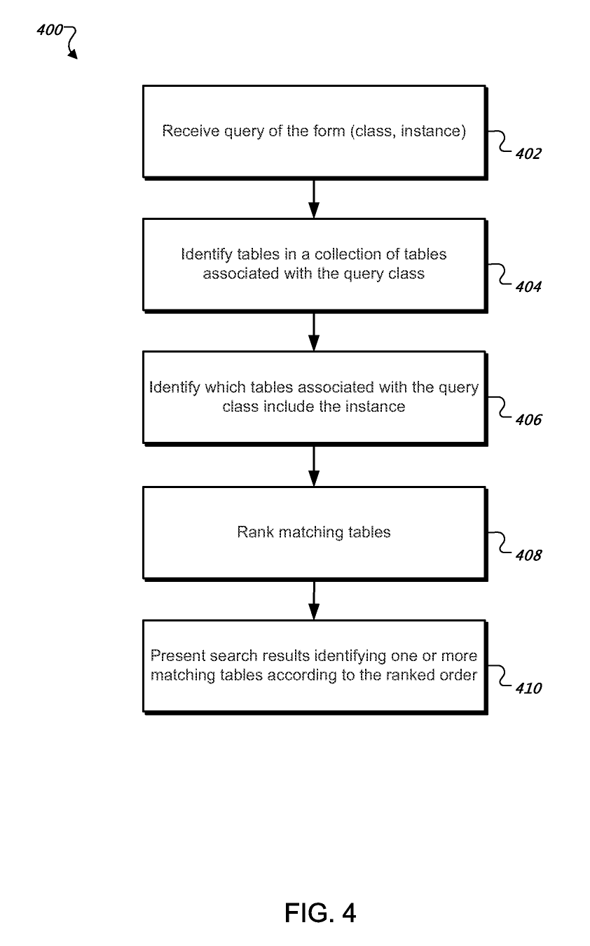

The system uses 206 the recovered semantic information to identify one or more tables responsive to a received query. The recovered semantic information guides a search such that tables are identified using the content of the query and the classification of the tables. Searching tables using recovered semantic information is described in greater detail below with respect to FIG. 4.

FIG. 3 is a flow diagram of an example method 300 for recovering semantic information from a table. For convenience, method 300 will be described with respect to a system including one or more computing devices that performs the method 300.

The system selects 302 a table. For example, the system can select a table from the collection of tables identified above in FIG. 1. The system identifies 304 a column in the table that is the subject of the table.

Many tables, e.g., on the web, provide the values of properties for a set of instances. In these tables there is often one column that stores the names of the instances. This column can be referred to as the subject column. For example, a table can describe the gross domestic product (“GDP”) of various countries. A first column can present particular countries while a second column can present corresponding GDP values. Thus, the GDP values are for the property GDP and the instances are each identified country. The column of country instances can be identified as the subject of the table. Table 1 below shows an example table of property values for a set of instances.

TABLE 1

| Country | GDP (in millions of USD) |
|---|---|
| US | 14,256,275 |
| Canada | 1,336,427 |
| Mexico | 874,903 |

The subject column need not be a key of the table and can contain duplicate values. For example, a table for coffee production by country can have two rows for Brazil (e.g., one for each harvesting season). Additionally, it is possible that the subject of the table is represented by more than one column. Furthermore, there are many tables that do not have a subject column. Consequently, it is possible that a subject is falsely assigned to these tables. However, these variations in table subject typically do not significantly effect the subject column identification for tables in the collection of tables. In particular, when a non-subject column is inadvertently identified as a subject, it is unlikely to be assigned a class label as described in greater detail below.

Two different techniques for identifying the subject column of a table are presented. In the first technique, the subject column is identified by scanning the columns of the table from left to right. The first column that is not a number or a date is selected as the subject column of the table.

In the second technique, a machine learning technique is used to identify the subject column. In particular, support vector machines (SVM) can be used to learn or train a classifier for subject columns in tables. SVMs are a set of related supervised learning methods used for classification and regression. For example, for particular training data composed of a set of training examples where each example is labeled as belonging to one of two categories, an SVM training algorithm builds a model that predicts which category a new example falls into.

The task of identifying the subject column in a table can be modeled as a binary classification problem. For each column in a table, the system computes features (see example features in Table 2 below) that are dependent on the name and type of the column and the values in different cells of the column. Given a set of labeled tables where the subject column is obscured or removed, a classification model is trained that uses the computed features to predict if a given column in a table is likely to be a subject column.

In particular the system uses a SVM classifier to train a model from a collection of labeled tables as training data. For example, human raters can identify and label subject columns of the tables in the training data. In some implementations, the system uses a different classifier. However, SVMs can provide results with unbalanced training data. In particular, in the training data the subject columns are far fewer than non-subject columns of the tables. The SVM can learn how to classify tables using features extracted from the tables in the training data. The features can include particular table properties for the collection of labeled tables.

The SVM attempts to discover a plane that separates the two classes of examples by the largest margin (e.g., examples can be considered points in space, mapped so that the examples of separate classes of examples are divided by a gap that is as wide as possible). A kernel function is often applied to the features to learn a hyperplane that might be non-linear in an original feature space. In some implementations, a radial basis function is used. While the system can use any suitable number of features that can be identified, using all of them can result in overfitting. To avoid overfitting, the system identifies a small subset of the features that are likely to be sufficient in predicting the subject column.

From the training data, the system measures a correlation of each of the features with a labeled prediction (e.g., whether or not the identified column of the table is a subject). The features are then sorted in decreasing order of correlation. For each value of k, the system considers the top k features (in order of correlation) and trains the SVM classifier on those top k features. The system can use n-fold cross-validation, i.e., dividing the training set into n parts and performing n runs, where for each run the system trains on (n−1) parts and tested on one. The system measures accuracy as a fraction of predictions (e.g., whether the column is a subject or not) that are correct for the columns in the test collection of tables.

For example, an average cross-validation accuracy as the number of features k increases suggests that accuracy can become flat for k>5. Additionally, the number of support vectors in the learned hypothesis can decrease for k≦5 and then starts to increase, indicating overfitting. Thus, in some implementations, the system identifies a set of 5 features that are sufficient for use in the SVM classifier. An example selected subset including 5 features are bold-faced in Table 2 below (features 1, 2, 5, 8, and 9).

TABLE 2
Subset of features used to classify columns

| No. | Feature Description |
|---|---|
| 1 | Fraction of cells with unique |
| | content |
| 2 | Fraction of cells with numeric |
| | content |
| 3 | Average number of letters in each |
| | cell |
| 4 | Average number of numeric tokens |
| | in each cell |
| 5 | Variance in the number of date |
| | tokens in each cell |
| 6 | Average number of data tokens in each |
| | cell |
| 7 | Average number of special characters |
| | in each cell |
| 8 | Average number of words in each |
| | cell |
| 9 | Column index from the left |
| 10 | Column index excluding numbers and |
| | dates |

Some of the features coincide with a baseline rule of selecting the first column (as described above). The SVM classifier, when applied on a new table, can identify more than one column to be the subject (since it is a binary classifier). However, there is typically only one subject column in a table. Consequently, rather than simply using the sign of the SVM decision function, the SVM result is adapted such that the system selects the column that has a highest value for the decision function. This can provide a high degree of subject column identification accuracy (e.g., 90+% accuracy).

The system identifies 304 an instance-class hierarchy. In particular, the system attaches classes to tables by mapping the subject column to an instance-class repository. The instance-class repository includes a collection of instance-class pairs having the form (instance, class) where each pair identifies an instance and an associated class label (e.g., singapore, southeast asian countries; or hepatitis, infectious diseases). The instance-class pairs can be mined from a collection of text (e.g., web text). Since the instance-class relations are transitive, the repository also corresponds to an informal class hierarchy. Thus, the instance-class hierarchy is formed from a set of (instance, class) Pairs.

The instance-class pairs can be extracted from the collection of text based on text that matches particular patterns, for example, text patterns having the form:

<[..] C [such as | including] I [and |,|.],

where I is a potential instance and C is a potential class label for the instance.

The boundaries of potential class labels, C, in the text are approximated from part-of-speech tags (e.g., using a parts of speech tagger) applied to the text (e.g., to words in text sentences), as a base (i.e., non-recursive) noun phrase whose last component is a plural-form noun. For example, the class label michigan counties is identified in the sentence “[..] michigan counties such as van buren, cass and kalamazoo [..]”. Thus, “van buren”, “cass”, and “kalamazoo” are specific instances of the class “michigan counties”.

The boundaries of instances I are identified, for example, by examining query logs to determine that I occurs as an entire query. In some implementations, since users type many queries in lower case, the collected data is converted to lower case before being matched to a query instance.

Thus, patterns can be extracted from a collection of documents (e.g., 100 million documents) and a collection of queries (e.g., 50 million anonymized queries). A threshold number of instances can be used identify a particular class label, e.g., at least 10 instances per class.

Additionally, class labels can cover closely-related concepts within various domains. For example, asian countries, east asian countries, southeast asian countries and south asian countries can all be present in the extracted data. Thus, the extracted class labels correspond to both a broad and relatively deep conceptualization of the potential classes of interest to web search users and to the creators of the web tables. The hierarchy of classes illustrate how particular instances can belong to different classes labels having different levels of specificity. In the example above, “Vietnam” can be an instance in multiple classes.

The system maps 308 the identified subject in the table to ranked instance-class pairs in the instance-class hierarchy. In particular, the instances in the column identified as the subject of the table are matched to instances of the instance-class pairs in the repository. Additionally, the matching instance-class pairs are scored such that a ranking of matching instance-class pairs can be determined. The score of a pair of an instance I and a class label C from the instance-class pair repository, which determines the relative rank of the class label for the instance, is computed as follows:

Score(I,C)=Size({Pattern(I,C)})²×Freq(I,C).

Thus, a class label C is deemed more relevant for an instance I if C is extracted by multiple extraction patterns and its original frequency count is higher. But high frequency counts associated with such a pair are sometimes not indicative of useful redundancy, but rather of merely near-duplicate sentences repeated in multiple documents. To control for duplicates, in some implementations, a sentence fingerprint is created for each source sentence, by applying a hash function to a specified number of characters (e.g., 250 characters) from the sentence. In some implementations, the system first converts punctuation to whitespace and reduces whitespace to a single space before applying the hash function. For any given pair of an instance and a class label extracted by a pattern, groups of near-duplicate source sentences, which have the same fingerprint, only increment the frequency count once for the entire group, rather than one for each sentence in the group.

The system labels 310 the table according to the mapped classes. The system identifies a set of classes that describe the instances occurring in the subject column of the table. These classes are a major component in the semantic description of the table's content. The system computes a candidate list of classes for each cell in the subject column, and derives the class labels for the column as a merged ranked list from the lists for every cell.

In some implementations, the system computes classes according to the following operations:

Input: IL, a list of cells from a table column
R, an instance-class repository
C-per-I, number of class labels to retrieve per instance
Output: CL, a ranked list of class labels
Variables: LV, list of lists of class labels
L, number of input cells available to use

### Steps:

### 1. L=Size(IL)

2. For index in [1, L]
3. I=ElementAt(IL, index)
4. LV[index]=empty list

### 5. if InRepository(I, R)

6. LV[index]=RetrieveClassLabels(R, I, C-per-I)

### 7. CL=MergeLists(LV)

### 8. Return CL

Since the input list of instances may be noisy and the lists of class labels may also be noisy, the system controls the number of candidate class labels output for each cell using the “C-per-I” class per instance parameter. In the MergeLists step, the per-instance retrieved lists of class labels are merged based on the relative ranks of the class labels within the retrieved lists to generate a MergedScore for the class as follows:

$$MergedScore ( C ) = \frac{\vert \{ L \} \vert}{{\sum }_{L} Rank ( C , L )} ,$$

where |{L}| is the number of input lists of class labels, and Rank(C, L) is the rank of C in the Lth list of class labels computed for the corresponding input instance. In some implementations, the rank is set to 1000 if C is not present in the Lth list. By using the relative ranks of the class labels within the input lists, and not their scores, the outcome of the merging is less sensitive to how class labels of a given instance are scored within the extracted labeled instances.

Thus, given an input table column, a ranked list of class labels is computed in decreasing order of the merged scores of each class label. In case of ties, the actual scores of the class labels within the extracted labeled instances can serve as a secondary ranking criterion. Thus, for a table subject a list of class labels is identified according to rank. In some implementations, a cutoff or threshold is established to limit the number of class labels assigned to the table (e.g., a specified number or score threshold).

As an example, for a given set of sample cell values from a table column {H, He Ni, F, Mg, Al, Si, Ti, Ar, Mn, Fr} the highest ranked class labels assigned to the table column using the above technique can be {elements, trace elements, metals, metal elements, metallic elements, heavy elements, additional elements, metal ions}.

FIG. 4 is a flow diagram of an example method 400 for searching tables using recovered table semantics. For convenience, method 400 will be described with respect to a system including one or more computing devices that performs the method 400.

The system receives 402 a query that includes a pair (C; P), where C is a class of instances and P is a property. For example, for a class “presidents” a property can be “political party”. Instances of that property in the class presidents can include “Republican” and “Democratic”. For example, in the following table, the class is “presidents” identified from the subject column and instances of the property “political party” are shown.

TABLE 3

| President | Political Party |
|---|---|
| Obama | Democratic |
| Bush | Republican |
| Clinton | Democratic |
| Bush | Republican |

A small number of other examples of properties that can be associated with a given class include:

| Class Name: | Property Names: |
|---|---|
| presidents | political party, birth |
| amino acids | mass, formula |
| antibiotics | brand name, side effects |
| apples | producer, market share |
| asian countries | gdp, currency |
| australian universities | acceptance rate, contact |
| infections | treatment, incidence |
| baseball teams | colors, captain |
| beers | taste, market share |
| board games | age, number of players |
| breakfast cereals | manufacturer, sugar content |
| broadway musicals | lead role, director |
| browsers | speed, memory requirements |
| capitals | country, attractions |
| cats | life span, weight |
| cereals | nutritional value, manufacturer |

The system identifies tables in the collection of tables associated with the query class. In particular, the system identifies 404 class labels that match C or that are similar to C (e.g., synonyms). In some implementations, similar classes are only identified when the query class is not found in the collection of tables. Additionally, tables that are labeled with C can also contain only a subset of C or named subclass of C.

The system identifies 406 which tables associated with the query class include the instance identified in the query. Thus, for the tables identified as associated with the query class, the system considers those tables for which there is also a corresponding property P.

The system ranks 408 the matching tables. In some implementations, the tables that match both class and property are ranked using one or more criteria. The criteria can include page rank, incoming anchor text, number of rows and tokens found in the body of table and the surrounding text.

In some implementations, the system estimates the size of the class C from the class-instance and attempts to find a table in the result whose size is close to C.

Alternatively, in some other implementations, the system applies a preference (e.g., a weight) for tables that are longer relative to shorter tables. For example, if the user is searching for Asian countries, then the longest table that was given that label is likely the most representative in that it will contain more countries from Asia than a shorter table with the same label, and it could not have been labeled Asian countries if it contained many countries that were not in Asia.

The system presents 410 search results identifying one or more matching tables according to the ranked order. For example, a search results user interface can present search results in a ranked list corresponding to the matched tables. These search results can provide links to the corresponding table resources or resources that include the identified tables. In some implementations, a thumbnail or other representation of the table results can be presented to the user. In some implementations, presenting search results further includes presenting one or more non-table results along with the search results identifying one or more matching tables. For example, the non-table results can include a listing of search results (e.g., one or more links to web pages) identifying resources responsive to the query.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a collection of tables, each table including a plurality of rows, each row including a plurality of cells;
recovering semantic information associated with each table of the collection of tables, the recovering including determining a class associated with each respective table according to a class-instance hierarchy including identifying a subject column of each table of the collection of tables; and
labeling each table in the collection of tables with the respective class.

2. The method of claim 1, where one or more tables are identified from web pages.

3. The method of claim 1, where a first column of each table is designated as the subject column of the table.

4. The method of claim 1, where a subject column of each table is identified using a support vector machine classifier.

5. The method of claim 1, where classifying each table into classes in a class-instance hierarchy includes identifying a ranked list of classes that describe instances in the subject column.

6. The method of claim 1, further comprising storing the collection of labeled tables.

7. The method of claim 6, further comprising receiving a query in a form of a class and property and using the collection of labeled tables to identify one or more labeled tables that match the class and the property.

8. The method of claim 1, further comprising:
identifying a class-instance hierarchy, the class-instance hierarchy being generated from a class-instance repository formed by identifying patterns from a collection of text and a collection of queries.

9. The method of claim 1, where classifying includes:
computing a candidate collection of classes for each cell in a subject column of the table; and
assigning class labels for the subject column of the table as a merged ranked list from the candidate lists for each cell.

10. A method performed by data processing apparatus, the method comprising:
receiving a query, the query having a plurality of terms where at least one term of the plurality of terms identifies a class and at least one term of the plurality of terms identifies a property of the class;
identifying tables in a collection of tables that are labeled with a same class as the query;
identifying one or more tables of the tables having the same class that also include the property of the query; and
ranking the one or more tables.

11. The method of claim 10, further comprising:
presenting at least one of the one or more tables for display.

12. The method of claim 11, wherein the at least one of the one or more tables are presented along with one or more non-table search results responsive to the query.

13. The method of claim 10, where the one or more tables are ranked according to a criteria based on the content of the one or more tables.

14. The method of claim 10, where the one or more tables are ranked according to a size of the one or more tables.

15. The method of claim 10, where each table of the collection of tables is labeled according to a class-instance hierarchy, where determining class for a particular table of the collection includes identifying a subject column of the table.

16. A computer storage medium encoded with a computer program, the program comprising instructions that when executed by data processing apparatus cause the data processing apparatus to perform operations comprising:
receiving a collection of tables, each table including a plurality of rows, each row including a plurality of cells;
recovering semantic information associated with each table of the collection of tables, the recovering including determining a class associated with each respective table according to a class-instance hierarchy including identifying a subject column of each table of the collection of tables; and
labeling each table in the collection of tables with the respective class.

17. The computer storage medium of claim 16, where one or more tables are identified from web pages.

18. The computer storage medium of claim 16, where a first column of each table is designated as the subject column of the table.

19. The computer storage medium of claim 16, where a subject column of each table is identified using a support vector machine classifier.

20. The computer storage medium of claim 16, where classifying each table into classes in a class-instance hierarchy includes identifying a ranked list of classes that describe instances in the subject column.

21. The computer storage medium of claim 16, further comprising instructions that when executed by data processing apparatus cause the data processing apparatus to perform operations comprising storing the collection of labeled tables.

22. The computer storage medium of claim 21, further comprising instructions that when executed by data processing apparatus cause the data processing apparatus to perform operations comprising receiving a query in a form of a class and property and using the collection of labeled tables to identify one or more labeled tables that match the class and the property.

23. The computer storage medium of claim 16, further comprising instructions that when executed by data processing apparatus cause the data processing apparatus to perform operations comprising:
identifying a class-instance hierarchy, the class-instance hierarchy being generated from a class-instance repository formed by identifying patterns from a collection of text and a collection of queries.

24. The computer storage medium of claim 16, where classifying includes:
computing a candidate collection of classes for each cell in a subject column of the table; and
assigning class labels for the subject column of the table as a merged ranked list from the candidate lists for each cell.

25. A computer storage medium encoded with a computer program, the program comprising instructions that when executed by data processing apparatus cause the data processing apparatus to perform operations comprising:
receiving a query, the query having a plurality of terms where at least one term of the plurality of terms identifies a class and at least one term of the plurality of terms identifies a property of the class;
identifying tables in a collection of tables that are labeled with a same class as the query;
identifying one or more tables of the tables having the same class that also include the property of the query; and
ranking the one or more tables.

26. The computer storage medium of claim 25, further comprising instructions that when executed by data processing apparatus cause the data processing apparatus to perform operations comprising:
presenting at least one of the one or more tables for display.

27. The computer storage medium of claim 26, wherein the at least one of the one or more tables are presented along with one or more non-table search results responsive to the query.

28. The computer storage medium of claim 25, where the one or more tables are ranked according to a criteria based on the content of the one or more tables.

29. The computer storage medium of claim 25, where the one or more tables are ranked according to a size of the one or more tables.

30. The computer storage medium of claim 25, where each table of the collection of tables is labeled according to a class-instance hierarchy, where determining class for a particular table of the collection includes identifying a subject column of the table.

31. A system comprising:
one or more processors configured to interact with a computer storage medium in order to perform operations comprising:
receiving a collection of tables, each table including a plurality of rows, each row including a plurality of cells;
recovering semantic information associated with each table of the collection of tables, the recovering including determining a class associated with each respective table according to a class-instance hierarchy including identifying a subject column of each table of the collection of tables; and
labeling each table in the collection of tables with the respective class.

32. The system of claim 31, where one or more tables are identified from web pages.

33. The system of claim 31, where classifying each table into classes in a class-instance hierarchy includes identifying a subject column of each table.

34. The system of claim 31, where a subject column of each table is identified using a support vector machine classifier.

35. The system of claim 31, where classifying each table into classes in a class-instance hierarchy includes identifying a ranked list of classes that describe instances in the subject column.

36. The system of claim 31, further configured to perform operations comprising storing the collection of labeled tables.

37. The system of claim 36, further configured to perform operations comprising receiving a query in a form of a class and property and using the collection of labeled tables to identify one or more labeled tables that match the class and the property.

38. The system of claim 31, further configured to perform operations comprising:
identifying a class-instance hierarchy, the class-instance hierarchy being generated from a class-instance repository formed by identifying patterns from a collection of text and a collection of queries.

39. The system of claim 31, where classifying includes:
computing a candidate collection of classes for each cell in a subject column of the table; and
assigning class labels for the subject column of the table as a merged ranked list from the candidate lists for each cell.

40. A system comprising:
one or more processors configured to interact with a computer storage medium in order to perform operations comprising:
receiving a query, the query having a plurality of terms where at least one term of the plurality of terms identifies a class and at least one term of the plurality of terms identifies a property of the class;
identifying tables in a collection of tables that are labeled with a same class as the query;
identifying one or more tables of the tables having the same class that also include the property of the query; and
ranking the one or more tables.

41. The system of claim 40, further configured to perform operations comprising:
presenting at least one of the one or more tables for display.

42. The system of claim 41, wherein the at least one of the one or more tables are presented along with one or more non-table search results responsive to the query.

43. The system of claim 40, where the one or more tables are ranked according to a criteria based on the content of the one or more tables.

44. The system of claim 40, where the one or more tables are ranked according to a size of the one or more tables.

45. The system of claim 40, where each table of the collection of tables is labeled according to a class-instance hierarchy, where determining class for a particular table of the collection includes identifying a subject column of the table.
